(19) United States
(12) Patent Application Publication
(10) Pub. No.: US 2006/0043638 A1
(43) Pub. Date: Mar. 2, 2006

(54) Method of forming microstructures with multiple discrete molds

(75) Inventors: Thomas R.J. Corrigan, St. Paul, MN (US); John R. Mlinar, Coon Rapids, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/204,206

(22) Filed: Aug. 15, 2005

Related U.S. Application Data
(60) Provisional application No. 60/604,558, filed on Aug. 26, 2004.
(60) Provisional application No. 60/604,559, filed on Aug. 26, 2004.

(51) Int. Cl. B29C 59/02; B29C 71/02

(52) U.S. Cl. 264/236; 264/293

(57) ABSTRACT

Described are methods of making microstructured (e.g., barrier ribs) articles employing a transfer apparatus.

### RELATED APPLICATIONS

This application claims priority to U.S. patent application Ser. Nos. 60/604558 and 60/604559 filed Aug. 26, 2004.

### BACKGROUND

Advancements in display technology, including the development of plasma display panels (PDPs) and plasma addressed liquid crystal (PALC) displays, have led to an interest in forming electrically-insulating ceramic barrier ribs on glass substrates. The ceramic barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way in which ceramic barrier ribs can be formed on glass substrates is by direct molding. This has involved laminating a planar rigid mold onto a substrate with a glass- or ceramic-forming composition disposed therebetween. The glass- or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

Although various methods of making microstructures such as barrier ribs have been described, industry would find advantage in alternative methods.

### SUMMARY

Presently described are methods of making a microstructured article. The method comprises providing at least two discrete molds, each mold having a microstructured surface and an opposing surface, wherein each mold is independently positionable; locating fiducials of a patterned substrate; and positioning each mold in response to the fiducials.

In one embodiment, the method employs applying a curable composition to the substrate and transferring each positioned mold such that the microstructured surface of the mold contacts the curable composition and the pattern of the substrate is aligned with the microstructured surface of the mold.

In another embodiment, the method employs filling the molds with a curable composition either prior to or after positioning the molds.

The method optionally employs removing unmolded portions of the curable composition. The method further employs curing the curable composition and removing the molds.

The microstructured surface may be suitable for making barrier ribs for a (e.g. plasma) display panel. In such embodiment, the substrate is typically a glass panel having an electrode pattern. The fiducials are electrodes or reference marks on the glass panel.

A drum or planar transfer assembly may be employed to transfer the positioned molds and contact the microstructured surface with the curable paste. The drum or planar transfer assembly may contact the opposing surface of the molds and transfer the molds by means of vacuum. The molds are typically released from the drum or planar transfer assembly prior to curing. The molds are aligned with a positioning error of no greater than 5 microns. The curable composition is typically applied to the substrate as at least two discrete coatings. Each discrete coating may correspond in dimensions to a single (e.g. plasma) display panel (e.g. 1 cm² to about 2 m²).

### BRIEF DESCRIPTION OF THE DRAWINGS

FIG. 1 is a schematic representation of an illustrative plasma display panel.

FIG. 2A is a planar view of a portion of an embodied method employing a transfer drum.

FIG. 2B is a perspective side view of an embodied method employing a transfer drum.

FIG. 3A is a planar view and 3B-3C are side views of an embodied positioning apparatus.

FIG. 4A-4C is a side view showing an embodied method employing a planar transfer assembly.

### DETAILED DESCRIPTION OF PREFERRED EMBODIMENTS

The present invention is believed to be applicable to methods of making microstructures on a substrate using a mold, as well as the articles and devices made using the methods. In particular, the present invention is directed to making ceramic microstructures on a substrate using a mold. Plasma display panels (PDPs) can be formed using the methods and provide a useful illustration of the methods. It will be recognized that other devices and articles can be formed using these methods including, for example, electrophoresis plates with capillary channels and lighting applications. In particular, devices and articles that can utilize molded ceramic microstructures can be formed using the methods described herein. While the present invention is not so limited, an appreciation of various aspects of the invention will be gained through a discussion of the examples provided below.

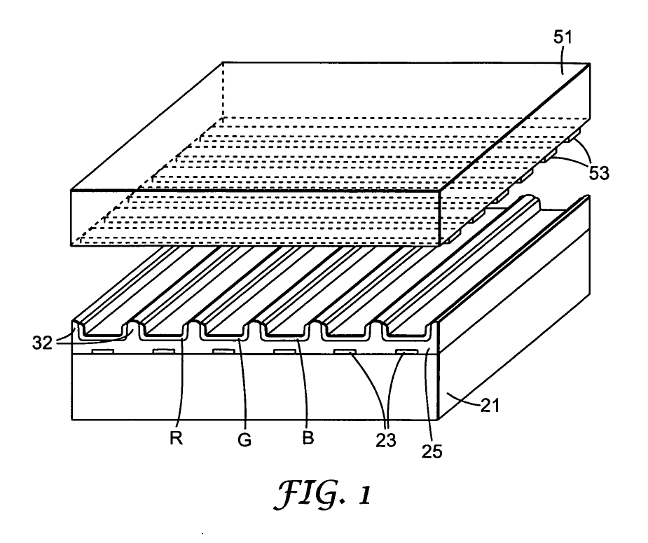

Plasma display panels (PDPs) have various components, as illustrated in FIG. 1. The back substrate, oriented away from the viewer, has independently addressable parallel electrodes 23. The back substrate 21 can be formed from a variety of compositions, for example, glass. Ceramic microstructures 25 are formed on the back substrate 21 and include barrier rib portions 32 that are positioned between electrodes 23 and separate areas in which red (R), green (G), and blue (B) phosphors are deposited. The front substrate includes a glass substrate 51 and a set of independently addressable parallel electrodes 53. These front electrodes 53, also called sustain electrodes, are oriented perpendicular to the back electrodes 23, also referred to as address electrodes. In a completed display, the area between the front and back substrate elements is filled with an inert gas. To light up a pixel, an electric field is applied between crossed sustain 53 and address electrodes 23 with enough strength to excite the inert gas atoms therebetween. The excited inert gas atoms emit ultraviolet (UV) radiation that causes the phosphor to emit red, green, or blue visible light.

Back substrate 21 is preferably a transparent glass substrate. Typically, for PDP applications back substrate 21 is made of soda lime glass that is optionally substantially free of alkali metals. The temperatures reached during processing can cause migration of the electrode material in the presence of alkali metal in the substrate. This migration can result in conductive pathways between electrodes, thereby shorting out adjacent electrodes or causing undesirable electrical interference between electrodes known as “crosstalk.” Front substrate 51 is typically a transparent glass substrate which preferably has the same or about the same coefficient of thermal expansion as that of the back substrate 21.

Electrodes 23, 53 are strips of conductive material. The electrodes 23 are formed of a conductive material such as, for example, copper, aluminum, or a silver-containing conductive frit. The electrodes can also be a transparent conductive material, such as indium tin oxide, especially in cases where it is desirable to have a transparent display panel. The electrodes are patterned on back substrate 21 and front substrate 51. For example, the electrodes can be formed as parallel strips spaced about 120 μm to 360 μm apart, having widths of about 50 μm to 75 μm, thicknesses of about 2 μm to 15 μm, and lengths that span the entire active display area which can range from a few centimeters to several tens of centimeters. In some instances the widths of the electrodes 23, 53 can be narrower than 50 μm or wider than 75 μm, depending on the architecture of the microstructures 25.

The height, pitch and width of the microstructured barrier ribs portions 32 in PDPs can vary depending on the desired finished article. The pitch (number per unit length) of the barrier ribs preferably matches the pitch of the electrodes. The height of the barrier ribs is generally at least 100 μm and typically at least 150 μm. Further, the height is typically no greater than 500 μm and typically less than 300 μm. The pitch of the barrier rib pattern may be different in the longitudinal direction in comparison to the transverse direction. The pitch is generally at least 100 μm and typically at least 200 μm. The pitch is typically no greater than 600 μm and typically less than 400 μm. The width of the barrier rib pattern may be different between the upper surface and the lower surface, particularly when the barrier ribs thus formed are tapered. The width is generally at least 10 μm, and typically at least 50 μm. Further, the width is generally no greater than 100 μm and typically less than 80 μm.

When using the methods of the present invention to make microstructures on a substrate (such as barrier ribs for a PDP), the coating material from which the microstructures are formed is preferably a slurry or paste containing a mixture of at least three components. The first component is a glass or ceramic forming particulate inorganic material (typically, a ceramic powder.) Generally, the inorganic material of the slurry or paste is ultimately fused or sintered by firing to form microstructures having desired physical properties adhered to the patterned substrate. The second component is a binder (e.g., a fugitive binder) that is capable of being shaped and subsequently hardened by curing or cooling. The binder allows the slurry or paste to be shaped into semi-rigid green state microstructures that are adhered to the substrate. The third component is a diluent that can promote release from the mold after alignment and hardening of the binder material, and can promote fast and complete burn out of the binder during debinding before firing the ceramic material of the microstructures. The diluent preferably remains a liquid after the binder is hardened so that the diluent phase-separates from the binder during binder hardening.

The amount of curable organic binder in the curable paste composition is typically at least 2 wt-%, more typically at least 5 wt-%, and more typically at least 10 wt-%. The amount of diluent in the rib precursor composition is typically at least 2 wt-%, more typically at least 5 wt-%, and more typically at least 10 wt-%. The totality of the organic components is typically at least 10 wt-%, at least 15 wt-%, or at least 20 wt-%. Further, the totality of the organic compounds is typically no greater than 50 wt-%. The amount of inorganic particulate material is typically at least 40 wt-%, at least 50 wt-%, or at least 60 wt-%. The amount of inorganic particulate material is no greater than 95 wt-%. The amount of additive is generally less than 10 wt-%.

A transfer apparatus is employed to transfer the positioned molds. In some embodiments, unfilled molds are transferred such that the microstructured surface of the mold contacts a curable composition that has been disposed upon a patterned substrate. In other embodiments, filled molds are transferred such that the microstructured surface of the mold contacts the patterned substrate. Various means may be employed to transfer the molds such as a drum and a planar transfer assembly.

The alignment of the molds with the glass panel is preferably accomplished by locating fiducials on the glass panel, locating fiducials on the mold, or a combination thereof and positioning each mold in response to the fiducials prior to contacting the patches of slurry or the glass substrate with the microstructured surface of the mold. The fiducials are typically located with a non-contact system such as a vision system (e.g. CCD camera) or a laser sensor system.

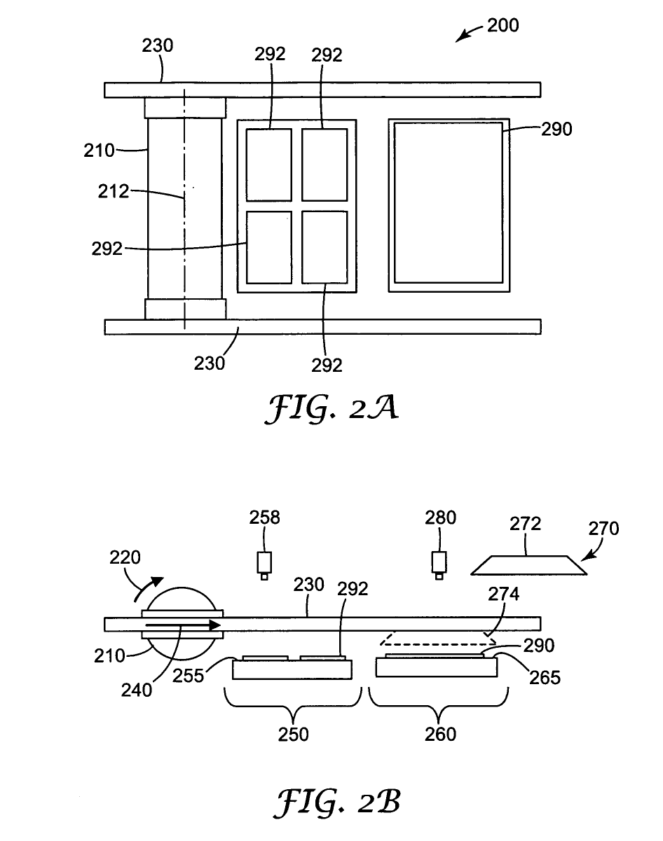

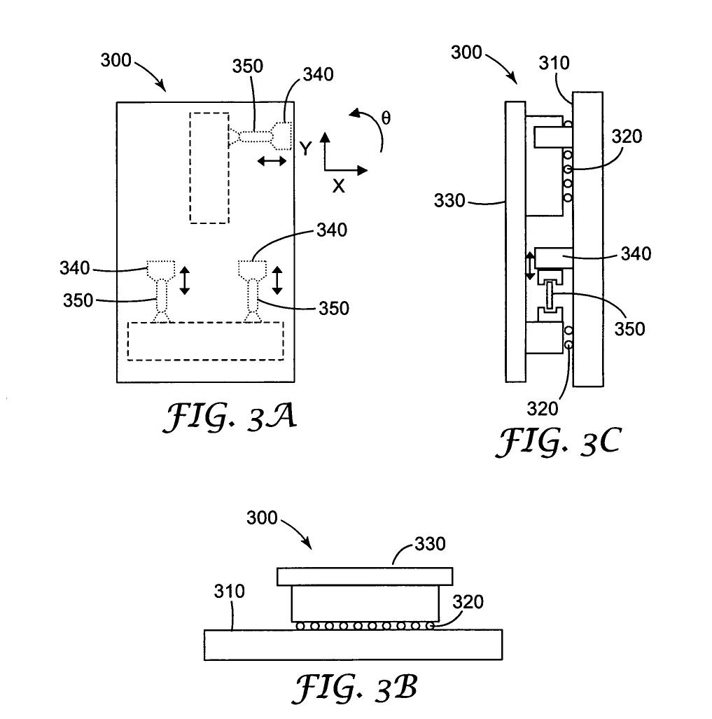

With reference to FIGS. 2A and 2B, a suitable transfer apparatus includes a cylindrical drum 210, for example having a 0.40 m diameter, a length of 2.30 m and having a top layer 6 mm thick of aluminum with 0.1 mm holes at 5 mm spacing across the entire surface. Internal baffles control the radial size of a continuous region of the surface exposed to a vacuum plenum. Two input shafts manipulate the baffles to control the angles of the exposed region. The drum can be mounted in two rotary air bearings and driven by a servomotor with precise sine-encoder (measuring step <0.001° such as Heidenhein ERO725) feedback, constituting a precision rotary axis system 220. The rotary axis system can be mounted in a frame on a precision linear axis system. The linear axis system can be supported by two linear air bearings 230 on either end of the drum, one constraining motion to a single horizontal axis, the other constraining motion to a horizontal plane. Two linear motors (not shown) drive the frame along the bearing system defining a linear axis 240. Precision sine-encoder feedback (±3 μsuch as Heidenhein LIF 181) may be used to control the position of each linear motor. The offset between linear motors can be adjusted to make the rotary axis orthogonal to their direction of travel. The rotary and linear axes may be controlled by a Programmable Multi-Axis Controller (such as a Turbo PMACII by Delta Tau). Suitable systems allow any point on the drum to be positioned above a prescribed point in a plane with an accuracy of ±5 μ. This positioning error is a combination of the controlled axes of motion (i.e. linear and rotary) and the mechanically constrained cross drum axis 212. The vertical height of the drum surface is also mechanically constrained, but to ±10 μ. The construction of such a precision positioning system is within the capabilities of various manufacturing companies such as Dover Instrument Corporation.

A suitable mold staging area 250 is provided within the workspace of the transfer drum. The mold staging area may consist of a flat surface 255 (e.g. 1.25 m by 2.30 m), made for example of granite, aligned to the linear axis of the transfer drum within ±5 μ. The mold staging area may optionally include presentation of the molds by an automated system. The mold staging area also includes an area for the disposal of expired mold tools optionally coupled with a mean for capturing unmolded slurry.

A precision Scara style robotic pick and place system (such as the Epson Robotics E2C25 or similar) integrated with a vision system 258 has a range of motion, and a custom vacuum gripper, to manipulate mold tools within the staging area (not shown). The vision feedback system allows precise (±2 μ) feedback on the location of molds on the staging area. This vision system is typically integrated by means of a computer with a second vision system 280 in the laminating area that can identify precisely (±2 μ) the location of fiducials on the glass panel.

A suitable laminating area 260 is provided within the workspace of the transfer roll system. The laminating area may also consist of a flat surface 265 (e.g. 1.25 m by 2.30 m), made for example of granite, aligned to the linear axis of the transfer drum within ±5 μ.

A bank of curing lights 270, of the proper wavelength to cure the slurry may be suspended above the laminating surface, and is moveable so the bank can be raised (e.g. to position 272) to clear the roll and vision system and lowered (e.g. to position 274) to close proximity with the flat surface.

During use, a part handling system moves a glass substrate 290 onto the flat surface of the laminating area. The glass substrate has two or more electrode patterns facing up, the number of electrode patterns corresponding to the number of molds to be transferred. A patch of slurry is coated on top of each of the electrode patterns. The vision system 280 locates the fiducials of each electrode pattern (e.g. located outside the slurry coated region) and the precision robot system positions each of the molds 292 in the staging area (with the patterns down) such that the molds are aligned with the corresponding set of fiducials on the glass panel. The transfer drum 210 advances across the staging area 250. The baffles are manipulated such that vacuum is enabled in the region tangent to the flat surface and after it rolls across the staging surface 255. The opposing surface of the molds are held to the surface of the transfer drum by means of the vacuum. Prior to reaching the laminating area, the entire drum can adjust its position in response to the vision system feedback to insure the drum is aligned with glass panel at the laminating area. The transfer drum then rolls across the laminating area contacting the microstructured surface of the molds into the regions of slurry on the glass substrate. Due to the independent positioning of each of the molds relative to each of the electrode patterns of the glass panel, the barrier ribs formed from the molds are aligned with the actual location of each electrode pattern on the glass substrate. The baffles in the drum are manipulated such that the vacuum region is reduced; shutting off vacuum as the roller reaches the location where the drum is tangent to the flat surface. In this way, the molds can be released immediately after being contacted with the slurry. The transfer drum may advance past the laminating area such that the curing lights can be lowered and used to cure the patches of slurry under the mold tools.

The transfer drum then moves back (in reverse direction) across the laminating area. The baffles are manipulated such that vacuum is turned on as the drum contacts the mold. The molds may have an extended flap that can be pulled by vacuum to the transfer drum to increase the initial surface area that is held onto the drum and thereby the amount of force that can be applied to initiate the release of the molds from the cured slurry.

The transfer drum may again adjust its position to return to its original alignment in the staging area. The transfer drum rolls across the staging area. The baffles are manipulated such that the vacuum regions are reduced; shutting off vacuum at the location the drum is tangent to the flat surface. In this way, the molds are released just as they are rolled across the staging surface. The mold tool may optionally be inspected such as with a vision system to determine if the mold is suitable for reuse. A robotic system can replace the mold with a new mold from the rack as needed. The inspection and optional replacement of the mold can occur concurrently while the next glass panel substrate is being brought to the laminating area by the part handling system.

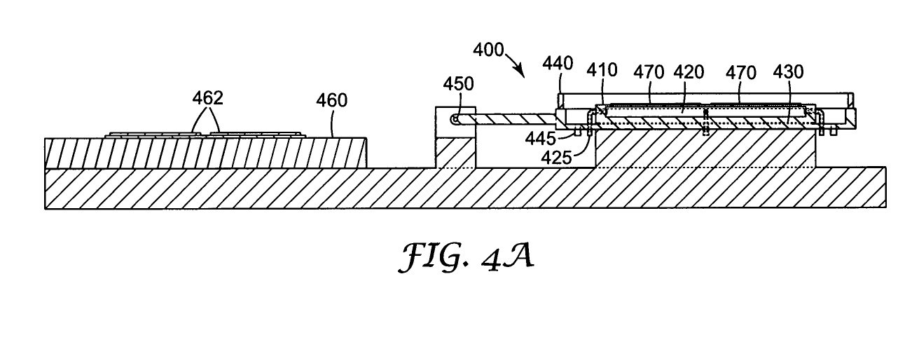

With reference to FIG. 3, an alternative mold staging area may consist of a number (e.g. 2 to 4 or more) of individual flat, non-sticky moveable surfaces 300 for supporting the mold tools. A kinematic system may be employed that allows each region to move independently in X, Y, and θ. The system includes actuators capable of independently moving each region ±100 μ in X and Y, and ±20° in θ. A control system is integrated with a vision feedback system 258 capable of locating fiducials (e.g. on all surfaces) of the mold tools and controlling their planar motion (X,Y,θ) with an accuracy of ±2 μ. This can be accomplished for example with a single flat metal plate with flexures cut into it to allow the three degrees of freedom (while remaining stiff in the vertical axis). Three small actuators may push on the flexures. Alternatively, a single flat surface 310 with independent air bearing systems 320 support the surface 330. Three actuators 340 push on each of the structures by means of coupling 350 to control its position. A plurality of moveable surfaces 300 can optionally be employed to replace the flat surface 255 in the staging area. In addition, the accuracy required of the robotic system can be reduced.

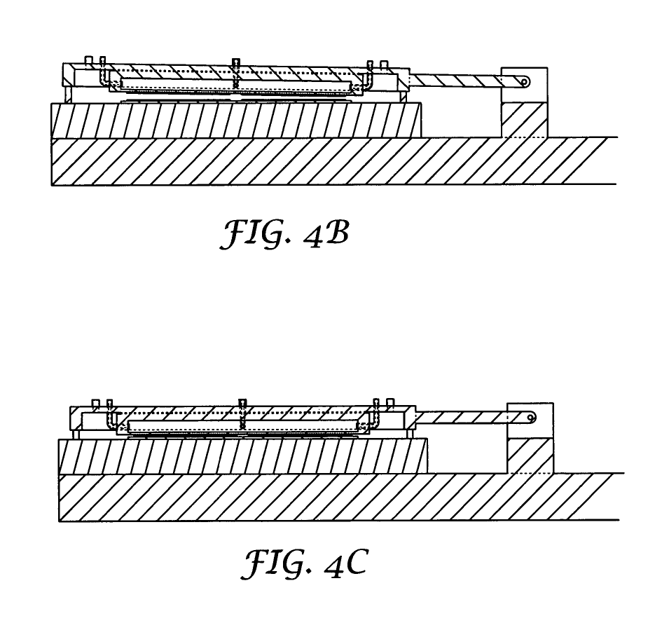

With references to FIG. 4A-4C, a suitable planar transfer assembly 400 may comprise a flat surface 410 with (e.g. 100 μdiameter) holes that connect to a vacuum plenum 420 that can be evacuated by a first vacuum source through a first vacuum input 425. The flat surface and the vacuum plenum float freely over a small range at interface 430 such that the flat surface can self align with any other surface it contacts. The planar transfer assembly also comprises a compliant gasket around its top perimeter 440, and a set of vacuum holes in an outer region fed by a second vacuum source through a second vacuum input 445. The planar transfer assembly comprises a drive mechanism for smoothly rotating the planar transfer assembly through 180 degrees of travel from the staging region to the laminating region employing a joint 450. Fittings are attached to both the first and second vacuum input locations. Additional valving allows compressed air alternately to be introduced to either input independently.

During use, a robotic part handling system delivers a glass substrate with electrode regions onto laminating surface 460 with the electrodes are facing up. Patches of slurry 462 have previously been coated onto the electrode regions of the glass substrate. A vision system guides the motion of the robot to orient the slurry covered electrode regions with respect to the general known workspace of the planar transfer assembly.

A vision feedback guided robotic system manipulates the mold sheets 470, microstructured side up, on the flat surface of the planar transfer assembly in the staging region. The molds are located relative to each other to match the location of the electrode regions on the glass substrate that is lying on the laminating surface with patches of slurry covering the electrodes. The mold sheets were previously placed in the approximate location by the vision guided robotic system.

Vacuum is applied to the flat surface through the first vacuum input of the planar transfer assembly to hold the mold sheets in place while the planar transfer assembly rotates into the Laminating Region. As it reaches the laminating surface, the flexible gasket deforms and forms a seal around the glass substrate, as shown FIG. 4B. At this point, the second vacuum source is activated to remove the air from above the glass substrate. The planar transfer assembly rotation stops briefly in this position.

The planar transfer assembly then slowly moves the last short distance pressing the mold sheets into the slurry on top of the glass substrate. The flat surface of the planar transfer assembly freely pivots to align itself with the plane of the glass substrate and evenly presses all of the mold sheets as shown in FIG. 4C. Both the vacuum sources are replaced with low-pressure compressed air (20-30 psi) releasing the mold tools and the planar transfer assembly. The planar transfer assembly then rotates back to the staging area. A bank of curing lights is then moved into position just above the mold sheets and the slurry is cured.

A vision feedback guided robotic system then mechanically grabs a flap of unstructured mold sheet material on one edge of one mold sheet and peels it out of the cured slurry. The vision feed back guided robotic system then places the mold sheet, structured side up on the planar transfer assembly. This mold removal process is repeated for each mold. A robotic part handling system then removes the coated glass substrate for further processing.

Alternatively a coating system could be used to fill the recesses of the mold sheets with patches of slurry while in the configuration of FIG. 4A, rather than coating onto the glass panel. The coating system may comprise a moving die head a pump and flexible tubing between the two. The coating system may employ the vision feedback system knowledge of the mold sheet locations to fill them with the correct amount of slurry.

Alternatively, the glass panel can be placed onto the flat surface 410 and the mold sheet can be arranged on flat surface 460. A vision system would again be used to locate the mold sheets relative to the fiducials on the glass panel.

The inorganic material is chosen based on the end application of the microstructures and the properties of the substrate to which the microstructures will be adhered. One consideration is the coefficient of thermal expansion (CTE) of the substrate material. Preferably, the CTE of the ceramic material of the slurry, when fired, differs from the CTE of the substrate material by no more than about 10%. When the substrate material has a CTE which is much less than or much greater than the CTE of the ceramic material of the microstructures, the microstructures can warp, crack, fracture, shift position, or completely break off from the substrate during processing or use. Further, the substrate can warp due to a high difference in CTE between the substrate and the ceramic micro structures.

The substrate is typically able to withstand the temperatures necessary to process the inorganic material of the slurry or paste. Glass or ceramic materials suitable for use in the slurry or paste preferably have softening temperatures of about 600° C. or less, and usually in the range of about 400° C. to 600° C. Thus, a preferred choice for the substrate is a glass, ceramic, metal, or other rigid material that has a softening temperature higher than that of the inorganic material of the slurry. Preferably, the substrate has a softening temperature that is higher than the temperature at which the microstructures are to be fired. If the material will not be fired, the substrate can also be made of materials, such as plastics. Inorganic materials suitable for use in the slurry or paste preferably have coefficients of thermal expansion of about 5×10⁻⁶/° C. to 13×10⁻⁶/° C. Thus, the substrate preferably has a CTE approximately in this range as well.

Choosing an inorganic material having a low softening temperature allows the use of a substrate also having a relatively low softening temperature. In the case of glass substrates, soda lime float glass having low softening temperatures is typically less expensive than glass having higher softening temperatures. Thus, the use of a low softening temperature inorganic material can allow the use of a less expensive glass substrate. The ability to fire green state barrier ribs at lower temperatures can reduce the thermal expansion and the amount of stress relief required during heating, thus avoiding undue substrate distortion, barrier rib warping, and barrier rib delamination.

Lower softening temperature inorganic materials can be obtained by incorporating certain amounts of alkali metals, lead, or bismuth into the material. However, for PDP barrier ribs, the presence of alkali metals in the microstructured barriers can cause material from the electrodes to migrate across the substrate during elevated temperature processing. The diffusion of electrode material can cause interference, or “crosstalk” , as well as shorts between adjacent electrodes, degrading device performance. Thus, for PDP applications, the inorganic powder of the slurry is preferably substantially free of alkali metal. When the incorporation of lead or bismuth is employed, low softening temperature ceramic material can be obtained using phosphate or B₂O₃-containing compositions. One such composition includes ZnO and B₂O₃. Another such composition includes BaO and B₂O₃. Another such composition includes ZnO, BaO, and B₂O₃. Another such composition includes La₂O₃ and B₂O₃. Another such composition includes Al₂O₃, ZnO, and P₂O₅.

Other fully soluble, insoluble, or partially soluble components can be incorporated into the inorganic material of the slurry to attain or modify various properties. For example, Al₂O₃ or La₂O₃ can be added to increase chemical durability of the composition and decrease corrosion. MgO can be added to increase the glass transition temperature or to increase the CTE of the composition. TiO₂ can be added to give the ceramic material a higher degree of optical opacity, whiteness, and reflectivity. Other components or metal oxides can be added to modify and tailor other properties of the inorganic material such as the CTE, softening temperature, optical properties, physical properties such as brittleness, and so on.

Other means of preparing a composition that can be fired at relatively low temperatures include coating core particles in the composition with a layer of low temperature fusing material. Examples of suitable core particles include ZrO₂, Al₂O₃, ZrO₂-SiO₂, and TiO₂. Examples of suitable low fusing temperature coating materials include B₂O₃, P₂O₅, and glasses based on one or more of B₂O₃, P₂O₅, and SiO₂. These coatings can be applied by various methods. A preferred method is a sol-gel process in which the core particles are dispersed in a wet chemical precursor of the coating material. The mixture is then dried and comminuted (if necessary) to separate the coated particles. These particles can be dispersed in the glass or ceramic powder of the slurry or paste or can be used by themselves for the glass powder of the slurry or paste.

The inorganic material in the slurry or paste is preferably provided in the form of particles that are dispersed throughout the slurry or paste. The preferred size of the particles depends on the size of the microstructures to be formed and aligned on the patterned substrate. Preferably, the average size, or diameter, of the particles in the inorganic material of the slurry or paste is no larger than about 10% to 15% the size of the smallest characteristic dimension of interest of the microstructures to be formed and aligned. For example, PDP barrier ribs can have widths of about 20 μm, and their widths are the smallest feature dimension of interest. For PDP barrier ribs of this size, the average particle size in the inorganic material is preferably no larger than about 2 or 3 μm. By using particles of this size or smaller, it is more likely that the microstructures will be replicated with the desired fidelity and that the surfaces of the inorganic microstructures will be relatively smooth. As the average particle size approaches the size of the microstructures, the slurry or paste containing the particles may no longer conform to the microstructured profile. In addition, the maximum surface roughness can vary based in part on the inorganic particle size. Thus, it is easier to form smoother structures using smaller particles.

The binder of the slurry or paste is an organic binder chosen based on factors such as the ability to bind to the inorganic material of the slurry or paste, the ability to be cured or otherwise hardened to retain a molded microstructure, the ability to adhere to the patterned substrate, and the ability to volatilize (or burn out) at temperatures at least somewhat lower than those used for firing the green state microstructures. The binder helps bind together the particles of the inorganic material when the binder is cured or hardened so that the mold can be removed to leave rigid green state microstructures adhered to and aligned with the patterned substrate. The binder can be referred to as a “fugitive binder” because, if desired, the binder material can be burned out of the microstructures at elevated temperatures prior to fusing or sintering the ceramic material in the microstructures. Preferably, firing substantially completely burns out the fugitive binder so that the microstructures left on the patterned surface of the substrate are fused glass or ceramic microstructures that are substantially free of carbon residue. In applications where the microstructures used are dielectric barriers, such as in PDPs, the binder is preferably a material capable of debinding at a temperature at least somewhat below the temperature desired for firing without leaving behind a significant amount of carbon that can degrade the dielectric properties of the microstructured barriers. For example, binder materials containing a significant proportion of aromatic hydrocarbons, such as phenolic resin materials, can leave graphitic carbon particles during debinding that can require significantly higher temperatures to completely remove.

The binder is preferably an organic material that is radiation or heat curable. Preferred classes of materials include acrylates and epoxies. Alternatively, the binder can be a thermoplastic material that is heated to a liquid state to conform to the mold and then cooled to a hardened state to form microstructures adhered to the substrate. When precise placement and alignment of the microstructures on the substrate is desired, it is preferable that the binder is radiation curable so that the binder can be hardened under isothermal conditions. Under isothermal conditions (no change in temperature), the mold, and therefore the slurry or paste in the mold, can be held in a fixed position relative to the pattern of the substrate during hardening of the binder material. This reduces the risk of shifting or expansion of the mold or the substrate, especially due to differential thermal expansion characteristics of the mold and the substrate, so that precise placement and alignment of the mold can be maintained as the slurry or paste is hardened.

When using a binder that is radiation curable, it is preferable to use a cure initiator that is activated by radiation to which the substrate is substantially transparent so that the slurry or paste can be cured by exposure through the substrate. For example, when the substrate is glass, the binder is preferably visible light curable. By curing the binder through the substrate, the slurry or paste adheres to the substrate first, and any shrinkage of the binder material during curing will tend to occur away from the mold and toward the surface of the substrate. This helps the microstructures demold and helps maintain the location and accuracy of the microstructure placement on the pattern of the substrate.

In addition, the selection of a cure initiator can depend on what materials are used for the inorganic material of the slurry or paste. For example, in applications where it is desirable to form ceramic microstructures that are opaque and diffusely reflective, it can be advantageous to include a certain amount of titania (TiO₂) in the ceramic material of the slurry or paste. While titania can be useful for increasing the reflectivity of the microstructures, it can also make curing with visible light difficult because visible light reflection by the titania in the slurry or paste can prevent sufficient absorption of the light by the cure initiator to effectively cure the binder. However, by selecting a cure initiator that is activated by radiation that can simultaneously propagate through the substrate and the titania particles, effective curing of the binder can take place. One example of such a cure initiator is bis(2,4,6-trimethylbenzoyl)-phenylphosphineoxide, a photoinitiator commercially available from Ciba Specialty Chemicals, Hawthrone, N.Y., under the trade designation Irgacure™ 819. Another example is a ternary photoinitiator system, as described in U.S. Pat. No. 5,545,670, incorporated herein by reference, including, for example, a mixture of ethyl dimethylaminobenzoate, camphoroquinone, and diphenyl iodonium hexafluorophosphate. Both of these examples are active in the blue region of the visible spectrum near the edge of the ultraviolet in a relatively narrow region where the radiation can penetrate both a glass substrate and titania particles in the slurry or paste. Other cure systems can be selected for use in the process of the present invention based on, for example, the binder, the components of the inorganic material in the slurry or paste, and the material of the mold or the substrate through which curing is to take place.

The diluent of the slurry or paste is generally a material selected based on factors such as, for example, the ability to enhance mold release properties of the slurry subsequent to curing the fugitive binder and the ability to enhance debinding properties of green state structures made using the slurry or paste. The diluent is preferably a material that is soluble in the binder prior to curing and remains liquid after curing the binder. By remaining a liquid when the binder is hardened, the diluent reduces the risk of the cured binder material adhering to the mold. Further, by remaining a liquid when the binder is hardened, the diluent phase separates from the binder material, thereby forming an interpenetrating network of small pockets, or droplets, of diluent dispersed throughout the cured binder matrix.

For many applications, such as PDP barrier ribs, it is desirable for debinding of the green state microstructures to be substantially complete before firing. Additionally, debinding is often the longest and highest temperature step in thermal processing. Thus, it is desirable for the slurry or paste to be capable of debinding relatively quickly and completely and at a relatively low temperature.

While not wishing to be bound by any theory, debinding can be thought of as being kinetically and thermodynamically limited by two temperature-dependent processes, namely diffusion and volatilization. Volatilization is the process by which decomposed binder molecules evaporate from a surface of the green state structures and thus leave a porous network for egress to proceed in a less obstructed manner. In a single-phase resin binder, internally trapped gaseous degradation products can blister and/or rupture the structure. This is more prevalent in binder systems that leave a high level of carbonaceous degradation products at the surface that can form an impervious skin layer to stop the egress of binder degradation gases. In some cases where single-phase binders are successful, the cross sectional area is relatively small and the binder degradation heating rate is sufficiently long to prevent a skin layer from forming.

The rate at which volatilization occurs depends on temperature, an activation energy for volatilization, and a frequency or sampling rate. Because volatilization occurs primarily at or near surfaces, the sampling rate is typically proportional to the total surface area of the structures. Diffusion is the process by which binder molecules migrate to surfaces from the bulk of the structures. Due to volatilization of binder material from the surfaces, there is a concentration gradient which tends to drive binder material toward the surfaces where there is a lower concentration. The rate of diffusion depends on, for example, temperature, an activation energy for diffusion, and a concentration.

Because volatilization is limited by the surface area, if the surface area is small relative to the bulk of the microstructures, heating too quickly can cause volatile species to be trapped. When the internal pressure gets large enough, the structures can bloat, break or fracture. To curtail this effect, debinding can be accomplished by a relatively gradual increase in temperature until debinding is complete. A lack of open channels for debinding, or debinding too quickly, can also lead to a higher tendency for residual carbon formation. This in turn may necessitate higher debinding temperatures to ensure substantially complete debinding. When debinding is complete, the temperature can be ramped up more quickly to the firing temperature and held at that temperature until firing is complete. At this point, the articles can then be cooled.

The diluent enhances debinding by providing shorter pathways for diffusion and increased surface area. The diluent preferably remains a liquid and phase separates from the binder when the binder is cured or otherwise hardened. This creates an interpenetrating network of pockets of diluent dispersed in a matrix of hardened binder material. The faster that curing or hardening of the binder material occurs, the smaller the pockets of diluent will be. Preferably, after hardening the binder, a relatively large amount of relatively small pockets of diluent are dispersed in a network throughout the green state structures. During debinding, the low molecular weight diluent can evaporate quickly at relatively low temperatures prior to decomposition of the other high molecular weight organic components. Evaporation of the diluent leaves behind a somewhat porous structure, thereby increasing the surface area from which remaining binder material can volatilize and decreasing the mean path length over which binder material must diffuse to reach these surfaces. Therefore, by including the diluent, the rate of volatilization during binder decomposition is increased by increasing the available surface area, thereby increasing the rate of volatilization for the same temperatures. This makes pressure build up due to limited diffusion rates less likely to occur. Furthermore, the relatively porous structure allows pressures that are built up to be released easier and at lower thresholds. The result is that debinding can typically be performed at a faster rate of temperature increase while lessening the risk of microstructure breakage. In addition, because of the increased surface area and decreased diffusion length, debinding is complete at a lower temperature.

The diluent is not simply a solvent compound for the binder. The diluent is preferably soluble enough to be incorporated into the binder in the uncured state. Upon curing of the binder of the slurry or paste, the diluent should phase separate from the monomers and/or oligomers participating in the cross-linking process. Preferably, the diluent phase separates to form discrete pockets of liquid material in a continuous matrix of cured binder, with the cured binder binding the particles of the glass frit or ceramic material of the slurry or paste. In this way, the physical integrity of the cured green state microstructures is not greatly compromised even when appreciably high levels of diluent are used (i.e., greater than about a 1:3 diluent to resin ratio).

Preferably the diluent has a lower affinity for bonding with the inorganic material of the slurry or paste than the affinity for bonding of the binder with the inorganic material. When hardened, the binder should bond with the particles of the inorganic material. This increases the structural integrity of the green state structures, especially after evaporation of the diluent. Other desired properties for the diluent will depend on the choice of inorganic material, the choice of binder material, the choice of cure initiator (if any), the choice of the substrate, and other additives (if any). Preferred classes of diluents include glycols and polyhydroxyls, examples of which include butanediols, ethylene glycols, and other polyols.

In addition to inorganic powder, binder, and diluent, the slurry or paste can optionally include other materials. For example, the slurry or paste can include an adhesion promoter to promote adhesion to the substrate. For glass substrates, or other substrates having silicon oxide or metal oxide surfaces, a silane coupling agent is a preferred choice as an adhesion promoter. A preferred silane coupling agent is a silane coupling agent having three alkoxy groups. Such a silane can optionally be pre-hydrolyzed for promoting better adhesion to glass substrates. A particularly preferred silane coupling agent is a silano primer such as sold by 3M Company, St. Paul, Minn. under the trade designation Scotchbond™ Ceramic Primer. Other optional additives can include materials such as dispersants that aid in mixing the inorganic material with the other components of the slurry or paste. Optional additives can also include surfactants, catalysts, anti-aging components, release enhancers, and so on.

Generally, the methods of the present invention typically use a mold to form the microstructures. The mold is preferably a flexible polymer sheet having a smooth surface and an opposing microstructured surface. The mold can be made by compression molding of a thermoplastic material using a master tool that has a microstructured pattern. The mold can also be made of a curable material that is cast and cured onto a thin, flexible polymer film. The molds may have curved surfaces connecting the barrier regions and land regions such as described in U.S. patent application No. 2003/0100192-A1. Further the material of the land portions may be continuous with the material of the barrier portions.

The microstructured mold can be formed, for example, according to a process like the processes disclosed in U.S. Pat. No. 5,175,030 (Lu et al.) and U.S. Pat. No. 5,183,597 (Lu), incorporated herein by reference. The formation process includes the following steps: (a) preparing an oligomeric resin composition; (b) depositing the oligomeric resin composition onto a master negative microstructured tooling surface in an amount barely sufficient to fill the cavities of the master; (c) filling the cavities by moving a bead of the composition between a preformed substrate and the master, at least one of which is flexible; and (d) curing the oligomeric composition.

The oligomeric resin composition of step (a) is preferably a one-part, solvent-free, radiation-polymerizable, crosslinkable, organic oligomeric composition, although other suitable materials can be used. The oligomeric composition is preferably one which is curable to form a flexible and dimensionally-stable cured polymer. The curing of the oligomeric resin preferably occurs with low shrinkage. One example of a suitable oligomeric composition is an aliphatic urethane acrylate such as one sold by the Henkel Corporation, Ambler, Pa., under the trade designation Photomer™ 6010. Similar compounds are available from other suppliers.

Acrylate and methacrylate functional monomers and oligomers are preferred because they polymerize more quickly under normal curing conditions. Further, a large variety of acrylate esters are commercially available. However, methacrylate, acrylamide and methacrylamide functional ingredients can also be used without restriction.

Polymerization can be accomplished by usual means, such as heating in the presence of free radical initiators, irradiation with ultraviolet or visible light in the presence of suitable photoinitiators, and irradiation with electron beam. One method of polymerization is by irradiation with ultraviolet or visible light in the presence of photoinitiator at a concentration of about 0.1 percent to about 1 percent by weight of the oligomeric composition. Higher concentrations can be used but are not normally needed to obtain the desired cured resin properties.

The viscosity of the oligomeric composition deposited in step (b) can be, for example, between 500 and 5000 centipoise (500 and 5000×10⁻³ Pascal-seconds). If the oligomeric composition has a viscosity above this range, air bubbles might become entrapped in the composition. Additionally, the composition might not completely fill the cavities in the master tooling. For this reason, the resin can be heated to lower the viscosity into the desired range. When an oligomeric composition with a viscosity below that range is used, the oligomeric composition can experience shrinkage upon curing that prevents the oligomeric composition from accurately replicating the master.

Various materials can be used for the base (substrate) of the patterned mold. Typically the material is substantially optically clear to the curing radiation and has enough strength to allow handling during casting of the microstructure. In addition, the material used for the base can be chosen so that it has sufficient thermal stability during processing and use of the mold. Polyethylene terephthalate or polycarbonate films are preferable for use as a substrate in step (c) because the materials are economical, optically transparent to curing radiation, and have good tensile strength. Substrate thicknesses of 0.025 millimeters to 0.5 millimeters are preferred and thicknesses of 0.075 millimeters to 0.175 millimeters are especially preferred. Other useful substrates for the microstructured mold include cellulose acetate butyrate, cellulose acetate propionate, polyether sulfone, polymethyl methacrylate, polyurethane, polyester, and polyvinyl chloride. The surface of the substrate may also be treated to promote adhesion to the oligomeric composition.

Examples of suitable polyethylene terephthalate based materials include: photograde polyethylene terephthalate; and polyethylene terephthalate (PET) having a surface that is formed according to the method described in U.S. Pat. No. 4,340,276, incorporated herein by reference.

A preferred master for use with the above-described method is a metallic tool. If the temperature of the curing and optional simultaneous heat treating step is not too great, the master can also be constructed from a thermoplastic material, such as a laminate of polyethylene and polypropylene.

After the oligomeric resin fills the cavities between the substrate and the master, the oligomeric resin is cured, removed from the master, and may or may not be heat treated to relieve any residual stresses. When curing of the mold resin material results in shrinkage of greater than about 5% (e.g., when a resin having a substantial portion of monomer or low molecular weight oligomers is used), it has been observed that the resulting microstructures may be distorted. The distortion that occurs is typically evidenced by concave microstructure sidewalls or slanted tops on features of the microstructures. Although these low viscosity resins perform well for replication of small, low aspect ratio microstructures, they are not preferred for relatively high aspect ratio microstructures for which the sidewall angles and the top flatness should be maintained. In forming inorganic barrier ribs for PDP applications, relatively high aspect ratio ribs are desired, and the maintenance of relatively straight sidewalls and tops on the barrier ribs can be important.

As indicated above, the mold can alternatively be replicated by compression molding a suitable thermoplastic against the master metal tool.

Various other aspects that may be utilized in the invention described herein are known in the art including, but not limited to each of the following patents that are incorporated herein by reference: U.S. Pat. No. 6,247,986; U.S. Pat. No. 6,537,645; U.S. Pat. No. 6,713,526; U.S. Pat. No. 6,843,952, U.S. Pat. No. 6,306,948; WO 99/60446; WO 2004/062870; WO 2004/007166; WO 03/032354; US2003/0098528; WO 2004/010452; WO 2004/064104; U.S. Pat. No. 6,761,607; U.S. Pat. No. 6,821,178; WO 2004/043664; WO 2004/062870; PCT Application No. US2005/0093202; PCT No. WO2005/019934; PCT No. WO2005/021260; PCT No. WO2005/013308; PCT No. WO2005/052974; PCT No. US04/43471 filed Dec. 22, 2004; U.S. patent applications Ser. Nos. 60/604556, 60/604557, 60/604558 and 60/604559, each filed Aug. 26, 2004.

What is claimed is:

1. A method of making a microstructured article comprising:
providing at least two discrete molds, each mold having a microstructured surface and an opposing surface, wherein each mold is independently positionable;
locating fiducials of a patterned substrate;
positioning each mold in response to the fiducials;
applying a curable composition to the substrate;
transferring each positioned mold such that the microstructured surface of the mold contacts the curable composition and the pattern of the substrates is aligned with the microstructured surface of the mold;
optionally removing unmolded portions of the curable composition;
curing the curable composition; and
removing the molds.

2. The method of claim 1 wherein the microstructured surface is suitable for making barrier ribs

3. The method of claim 1 wherein the substrate is a glass panel and the pattern is an electrode pattern.

4. The method of claim 3 wherein the fiducials are electrodes or reference marks on the glass substrate.

5. The method of claim 1 wherein a drum or planar transfer assembly is employed to transfer the aligned molds and contact the microstructured surface of the mold with the curable paste.

6. The method of claim 5 wherein the drum or planar transfer assembly transfers the opposing surface of the molds by means of vacuum.

7. The method of claim 6 wherein the molds are released from the drum or planar transfer assembly prior to curing.

8. The method of claim 1 wherein the molds are aligned with a positioning error of no greater than 5 microns.

9. The method of claim 1 wherein two or more discrete coatings of the curable composition is applied to a single substrate.

10. The method of claim 9 wherein each discrete coating corresponds in size to a single plasma display panel.

11. The method of claim 9 wherein each discrete coating ranges in size from about 1 cm² to about 2 m².

12. The method of claim 1 wherein a visual feedback system is employed to locate the fiducials, position the molds, and optionally apply the curable composition.

13. The method of claim 1 wherein the mold is transparent.

14. The method of claim 1 wherein the curable composition is cured through the mold, cured through the glass panel, or a combination thereof.

15. The method of claim 1 wherein the mold is comprised of a polymeric material.

16. The method of claim 1 wherein the curable composition of each mold is cured sequentially or concurrently.

17. The method of claim 1 wherein the molds are removed from the cured paste by being pulled from a leading edge.

18. The method of claim 1 wherein each mold is unstretched while aligned.

19. A method of making a microstructured article comprising:
providing at least two discrete molds, each mold having a microstructured surface and an opposing surface, wherein each mold is independently positionable;
filling the molds with a curable composition,
locating fiducials of a patterned substrate;
positioning each mold in response to the fiducials;
transferring each positioned filled mold onto the substrate such that the pattern of the substrate is aligned with the microstructured surface of the mold;
curing the paste; and
removing the molds.

20. The method of claim 19 wherein the molds are filled after positioning.
